(19) United States
(12) Patent Application Publication
(10) Pub. No.: US 2023/0193746 A1
(43) Pub. Date: Jun. 22, 2023

(54) Microseismic Processing Using Fiber-Derived Flow Data

(71) Applicant: SCHLUMBERGER TECHNOLOGY CORPORATION, SUGAR LAND, TX (US)

(72) Inventors: Joel Herve Le Calvez, Richmond, TX (US); Colin Allan Wilson, Tolworth (GB); Kari Anne Hoier Kjolaas-Holland, Oklahoma City, OK (US)

(21) Appl. No.: 18/066,545

(22) Filed: Dec. 15, 2022

Related U.S. Application Data
(63) Continuation of application No. 16/338,986, filed on Apr. 2, 2019, now abandoned.
(60) Provisional application No. 62/407,698, filed on Oct. 13, 2016.

(51) Int. Cl. E21B 47/107; G06F 30/20; E21B 47/135; E21B 43/263; G01V 8/16; G02B 6/44

(52) U.S. Cl. CPC E21B 47/107; G06F 30/20; E21B 47/135; E21B 43/263; G01V 8/16; G02B 6/4415; G01V 2210/1425; G01V 1/42

(57) ABSTRACT

A method, downhole tool, and system, of which the method includes deploying a perforation charge into a wellbore, signaling the perforation charge to detonate, deploying a cable into the wellbore, determining a fluid flow rate at a predetermined location in the wellbore using the cable, and determining whether the perforation charge detonated at the predetermined location based on the fluid flow rate.

### CROSS-REFERENCE TO RELATED APPLICATIONS

This application claims priority to U.S. Provisional Patent Application having Ser. No. 62/407,698, which was filed on Oct. 13, 2016, and is incorporated herein by reference in its entirety.

### BACKGROUND

Hydraulic fracturing technology uses recorded microseismic and seismic events, collectively referred to as “seismic events,” for the determination of the extent of rock fracturing induced by the reservoir stimulation methods. This procedure is commonly referred to as “hydraulic fracture monitoring” (HFM).

A variety of reservoir stimulation methods exist, which for the sake of simplicity are referred to herein simply as “hydraulic fracturing.” Hydraulic fracturing may be done in stages that have durations as long as several hours. Generally, perforation charges are deployed into the wellbore, to predetermined positions, and detonated in sequence. When fired correctly, the perforation charges detonate at the programmed depths. The acoustic signals generated by the explosions are recorded and analyzed as part of the HFM process. The analysis can be employed to calibrate velocity models of the subterranean domain between the charge (acting as a hypocenter for the seismic event) and the recording device, e.g., at the surface, and/or to calibrate tool-face orientation models.

In some instances, however, not all the explosives are detonated or fully detonated, leaving some perforations incomplete and/or otherwise not as planned. Further, the detonations may be “off-depth”, detonating at a position that is other than what was expected. Thus, the underlying information for the tool orientation/velocity model calibrations may be inaccurate.

To determine if the perforations have been properly formed and at the expected depths, a camera may be lowered into the wellbore to allow for visual inspection. While successfully employed in various contexts, this technique can be expensive, slow, and may have its own risk of failure. To avoid these drawbacks, operators sometimes forego ascertaining whether the initial assumption of an on-depth, full detonation is correct, resulting in uncertainties that may hinder the model calibrations or impact other results.

### SUMMARY

Embodiments of the disclosure may provide a method including deploying a perforation charge into a wellbore, signaling the perforation charge to detonate, deploying a cable into the wellbore, determining a fluid flow rate at a predetermined location in the wellbore using the cable, and determining whether the perforation charge detonated at the predetermined location based on the fluid flow rate.

Embodiments of the disclosure may also provide a system including a downhole tool that includes one or more perforation charges, the downhole tool is configured to be run into a wellbore, and the one or more perforation charges are configured to detonate in response to a signal. The system also includes a cable configured to be run into the wellbore, after the wellbore is perforated, and to measure a physical characteristic of the wellbore at least at a predetermined location. The physical characteristic is indicative of a flow rate of fluid in the wellbore at the predetermined location. The system also includes a processor configured determine whether the one or more perforation charges detonated at the predetermined location based on the fluid flow rate at the predetermined location.

Embodiments of the disclosure may further provide a system including a downhole tool that includes a perforation charge configured to detonate in response to a signal. The downhole tool is configured to be deployed into a wellbore. The system also includes a cable configured to be deployed into the wellbore, and a computing system including one or more processors, and a memory system including one or more non-transitory, computer-readable media storing instructions that, when executed, are configured to cause the computing system to perform operations. The operations include determining a fluid flow rate at a predetermined location in the wellbore using the cable, and determining whether the perforation charge detonated at the predetermined location based on the fluid flow rate.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIGS. 1A, 1B, 1C, 1D, 2, 3A, and 3B illustrate simplified, schematic views of an oilfield and its operation, according to an embodiment.

FIG. 4 illustrates a schematic side view of a well system, according to an embodiment.

FIG. 5 illustrates a flowchart of a method for treating a well, according to an embodiment.

FIG. 6 illustrates a schematic view of a computing system, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object, and, similarly, a second object could be termed a first object, without departing from the scope of the invention. The first object and the second object are both objects, respectively, but they are not to be considered the same object.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

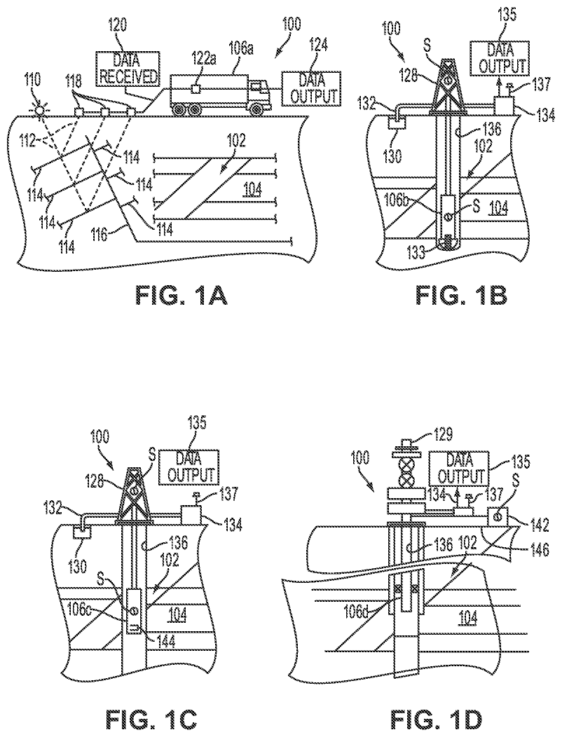

FIGS. 1A-1D illustrate simplified, schematic views of oilfield 100 having subterranean formation 102 containing reservoir 104 therein in accordance with implementations of various technologies and techniques described herein. FIG. 1A illustrates a survey operation being performed by a survey tool, such as seismic truck 106.1, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 1B illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106.3 suspended by rig 128 and into wellbore 136 of FIG. 1B. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 1A. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 1D illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part of, or the entirety, of oilfield 100 may be on land, water and/or sea. Also, while a single field measured at a single location is depicted, oilfield applications may be utilized with any combination of one or more oilfields, one or more processing facilities and one or more wellsites.

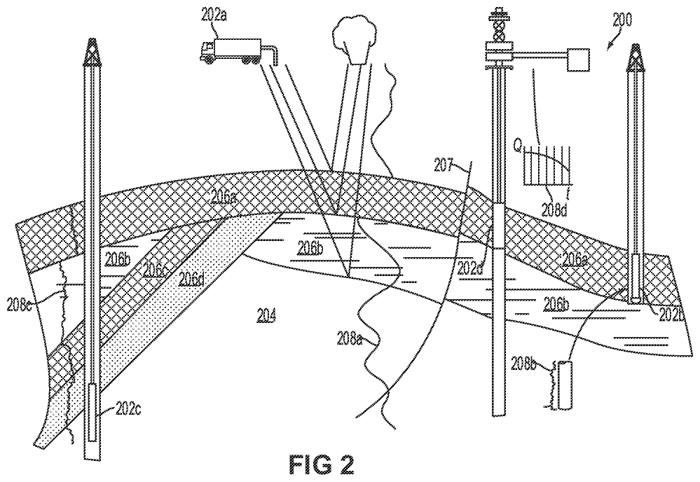

FIG. 2 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 1A-1D, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively; however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that typically provides a resistivity or other measurement of the formation at various depths.

A production decline curve or graph 208.4 is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208.1 from data acquisition tool 202.1 is used by a geophysicist to determine characteristics of the subterranean formations and features. The core data shown in static plot 208.2 and/or log data from well log 208.3 are typically used by a geologist to determine various characteristics of the subterranean formation. The production data from graph 208.4 is typically used by the reservoir engineer to determine fluid flow reservoir characteristics. The data analyzed by the geologist, geophysicist and the reservoir engineer may be analyzed using modeling techniques.

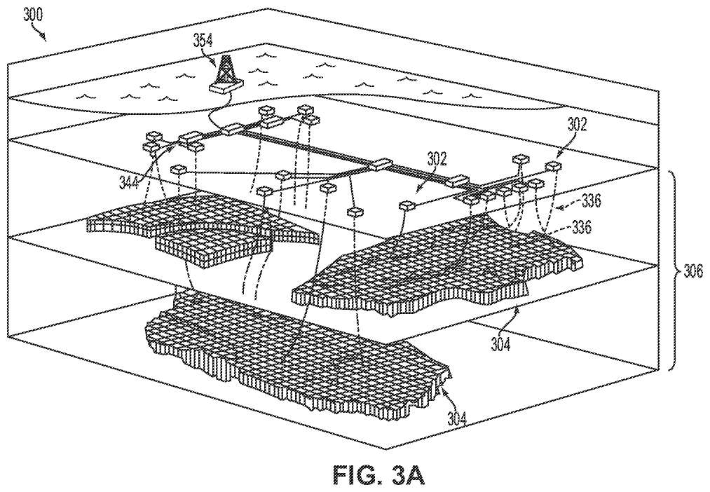

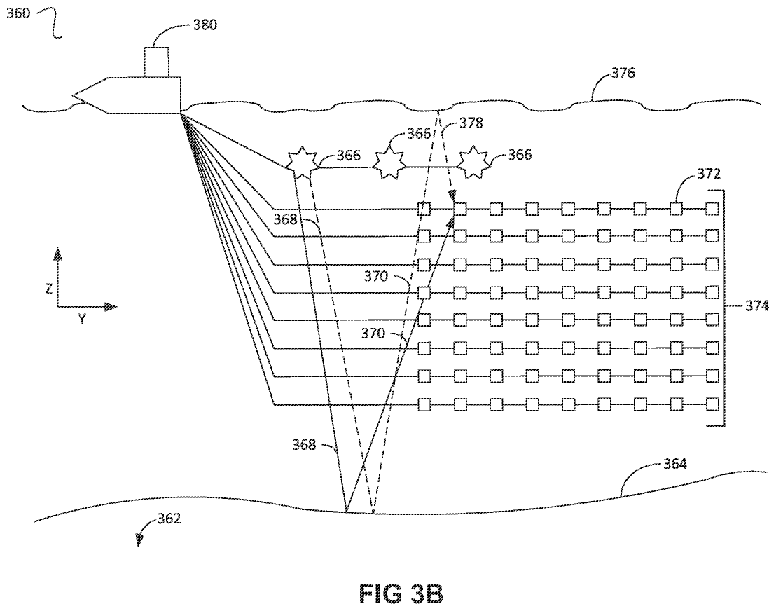

FIG. 3A illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3A is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

Attention is now directed to FIG. 3B, which illustrates a side view of a marine-based survey 360 of a subterranean subsurface 362 in accordance with one or more implementations of various techniques described herein. Subsurface 362 includes seafloor surface 364. Seismic sources 366 may include marine sources such as vibroseis or airguns, which may propagate seismic waves 368 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90 Hz) over time.

The component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Marine seismic acquisition systems tow each streamer in streamer array 374 at the same depth (e.g., 5-10 m). However, marine based survey 360 may tow each streamer in streamer array 374 at different depths such that seismic data may be acquired and processed in a manner that avoids the effects of destructive interference due to sea-surface ghost waves. For instance, marine-based survey 360 of FIG. 3B illustrates eight streamers towed by vessel 380 at eight different depths. The depth of each streamer may be controlled and maintained using the birds disposed on each streamer.

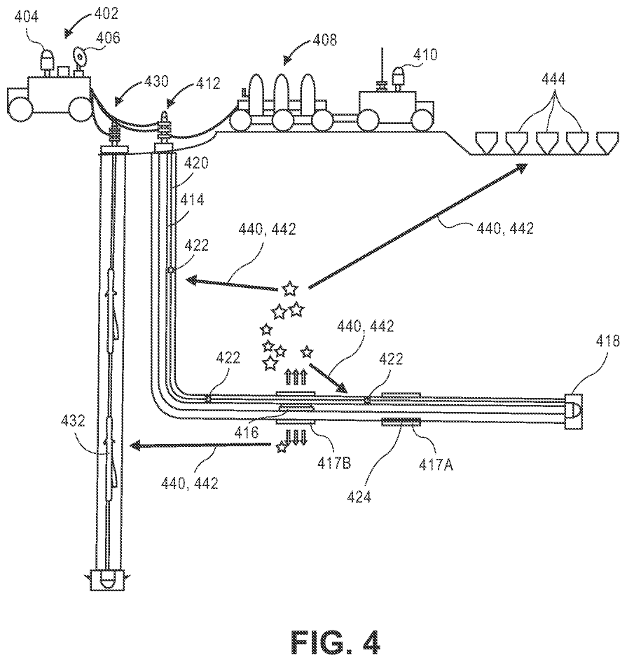

FIG. 4 illustrates a schematic side view of a wellsite 400, according to an embodiment. The wellsite 400 may include a recording unit 402 at the surface. As shown, the recording unit 402 may be a truck having a global positioning system (“GPS”) 404 and/or a satellite system 406. The wellsite 400 may also have a pump unit 408 at the surface. As shown, the pump unit 408 may be part of a frac van, which may also have a GPS 410. The pump unit 408 may be configured to pump fluid into a wellbore to fracture the surrounding subterranean formation.

A first (e.g., production) wellbore 412 may be provided and extend downward into the subterranean formation from the surface. As shown, the first wellbore 412 may have a substantially vertical portion and a substantially horizontal portion; however, in other embodiments, the first wellbore 412 may extend other directions, primarily vertically, primarily laterally, or may have another shape. The first wellbore 412 may have one or more tubular members 414 positioned therein. The tubular members 414 may be or include casing segments, liner segments, drill pipe segments, or the like. For example, the tubular members 414 may be drill pipe segments that form a drill string.

A first downhole tool 416 may be coupled to the drill string 414. The first downhole tool 416 may be or include a perforating device (e.g., a perforating gun) including one or more charges that create perforations 417A, 417B in the first wellbore 412 and/or the tubular members 414. One or more plugs 418 may also be positioned within the first wellbore 412.

A cable 420 may also be positioned in the first wellbore 412. The cable 420 may be positioned within the tubular members 414 or in an annulus between the tubular members 414 and a wall of the first wellbore 412. The cable 420 may also be placed behind the casing (e.g., cement). The cable 420 may include one or more fiber optic cables or “fibers,” which may provide one or more intrinsic fiber optic sensors configured to measure one or more physical characteristics of the first wellbore 412 (e.g., temperature, pressure, vibration, strain, pressure (P) waves 440, shear (S) waves 442, or a combination thereof). In some embodiments, the intrinsic fiber optic sensors may be configured to measure the one or more physical characteristics across a range of positions (depths) in the first wellbore 412, e.g., in order to determine whether fluid flow is occurring, even if not precisely where expected, as will be discussed in greater detail below. In another embodiment, one or more sensors 422 may be coupled to the cable 420 and be configured to measure the one or more physical characteristics. Accordingly, the cable 420 may provide a fiber optic signal relay for the extrinsic sensors 422 coupled thereto.

In at least one embodiment, a second (e.g., monitoring) wellbore 430 may be positioned proximate to the first wellbore 412 in the subterranean formation. The second wellbore 430 may extend deeper into the subterranean formation than the first wellbore 412. A seismic sensor 432 may be positioned within the second wellbore 430. The seismic sensor 432 may be configured to sense P waves 440 and/or S waves 442. In at least some embodiments, the second wellbore 430 and/or the second seismic sensor 432 may be omitted.

In some embodiments, the wellsite 400 may also include one or more seismic sensors 444 positioned at the surface. The P waves 440 and/or the S waves 442 may also or instead be captured using the seismic sensors 444. A velocity model may be generated, based on the time difference between the generation of seismic waves in the first wellbore 430 (e.g., detonating a charge) and the recording of such waves in by the seismic sensors 432 or 444 and the distance between the seismic sensors 432 or 444 and the location of the detonation. The velocity model may provide insight to the subterranean formation between the location of the detonation and the seismic sensors 432 or 444.

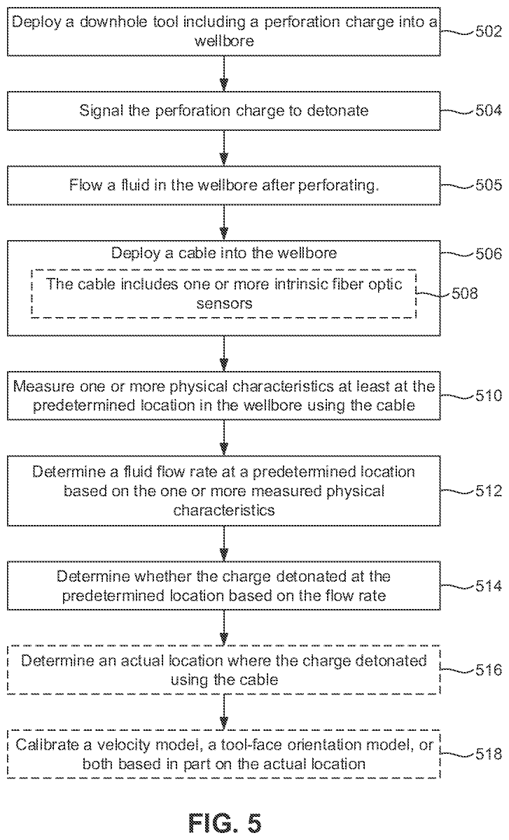

FIG. 5 illustrates a flowchart of a method 500 for treating a well, according to an embodiment. Some embodiments of the method 500 may be understood with reference to the wellsite 400 of FIG. 4; however, the method 500 is not restricted to any particular structure unless otherwise stated herein.

The method 500 may include deploying a downhole tool 416, including one or more perforation charges, to one or more positions (depths) in the wellbore 412, as at 502. In some cases, the positions to which the charges are deployed may correspond to predetermined perforation/fracturing locations along the wellbore 412. In other cases, however, at least one of the one or more perforation charges may be positioned at an unexpected position, e.g., “off depth”.

The method 500 may then include signaling the one or more perforation charges to detonate, as at 504. In response to the signal to detonate, one or more of the charges may fully detonate, incompletely (partially) detonate, or not detonate. When the charges fully detonate, a perforation in the wellbore 412 (e.g., through the casing, liner, cement, wellbore wall, etc.) may be generated, and hydraulic fracturing of the surrounding formation, through this perforation, may be enabled. When the charges incompletely detonate, a perforation may or may not be formed, and, if formed, the perforation may be smaller or incomplete than designed. When the charges do not detonate, no perforation may be generated.

After signaling for detonation, the method 500 may include initiating a fluid flow in the wellbore, as at 505. The fluid that flows in the wellbore 412 may be or include fracturing fluid, water, etc.

The method 500 may further include deploying one or more cables 420 into the first wellbore 412, as at 506. In at least one embodiment, the one or more cables 420 may be or be connected to one or more sensors configured to detect fluid flow by measuring one or more characteristics in the wellbore 412. For example, the cables 420 may be or include one or more intrinsic fiber optic sensors configured to detect one or more such physical characteristics along at least a portion of the length thereof, as indicated at 508.

The method 500 may also include measuring one or more physical characteristics in the wellbore 412, at least at the predetermined location (where detonation is planned to have occurred), as at 510. The cable 420 may be employed or take this measurement, as explained above. In some embodiments, the measurements may be heterodyne distributed vibration sensing (hDVS) based measurements.

The method 500 may further include determining a fluid flow rate at a predetermined location based on the one or more measured physical characteristics, as at 512. “Determining the flow rate” may mean establishing a numerical value for the flow rate with set units to a reasonable degree of certainty. In other embodiments, however, “determining the flow rate” may mean a binary determination of “flowing/not flowing.”

The method 500 may include determining whether the one or more charges detonated at the predetermined location based on the one or more measurements, as at 510. In some embodiments, the measurements may be acquired at the predetermined location, providing an indication of whether, and potentially to what extent, fluid is flowing (e.g., through the perforations 417A, 417B) at the predetermined location. If fluid is flowing (e.g., at or above an expected rate), it may be inferred that perforation was successful. If fluid is not flowing at the predetermined location (e.g., below an expected rate or not at all), then it may be concluded that the charge did not form the perforation as expected, either not detonating properly or not detonating at the predetermined location.

In some embodiments, the method 500 may include, in response to determining that the one or more charges did not detonate at the predetermined location, determining whether the one or more charges detonated at another location, as at 512. For example, the measurements may be taken at a range of depths along a portion of the cable 420. The predetermined location may be in this range.

Thus, if the fluid flow is occurring at a certain rate at the predetermined location, then it may be determined that the detonation occurred as expected, at the predetermined location. Otherwise, if fluid flow measurements indicate that fluid flow is not occurring at the predetermined location and/or is occurring elsewhere (an “actual” location where detonation occurred) in the range, it may be determined that the one or more charges did not detonate at the predetermined location, but detonated at the actual location, and the actual location may be established. In some embodiments, however, this may be omitted, as it may be sufficient to determine that the detonation did not occur at the predetermined location, or it may be determined that detonation did not occur at all.

The method 500 may further include calibrating a velocity model, a tool-face calibration model, or both based in part on the actual location where detonation occurred (if it occurred), as at 518. For example, the velocity model may be a seismic model that is calibrated based on a known distance and known time, i.e., the distance between a seismic receiver (e.g., receivers 432 and 444) and the hypocenter (represented by the actual location of detonation), and the known time between detonation and arrival of the seismic waves at the receiver.

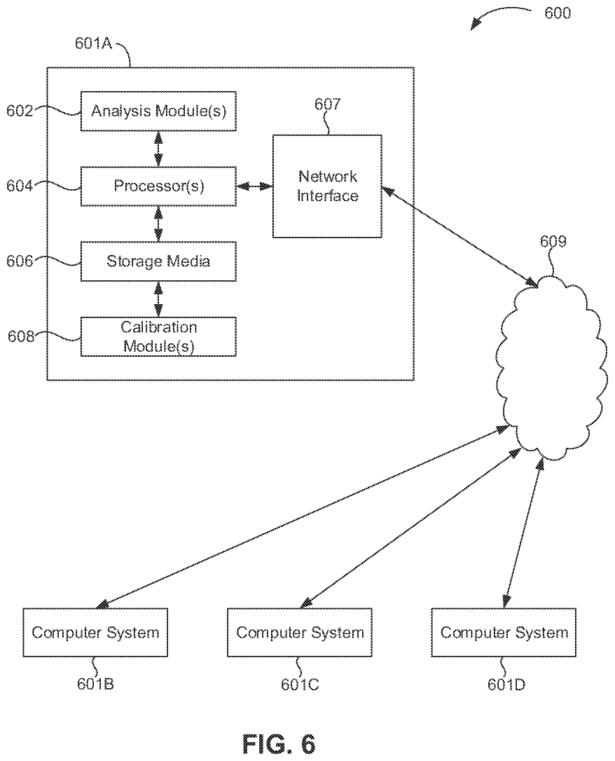

FIG. 6 illustrates an example of such a computing system 600, in accordance with some embodiments. The computing system 600 may include a computer or computer system 601A, which may be an individual computer system 601A or an arrangement of distributed computer systems. The computer system 601A includes one or more analysis module(s) 602 configured to perform various tasks according to some embodiments, such as one or more methods disclosed herein. To perform these various tasks, the analysis module 602 executes independently, or in coordination with, one or more processors 604, which is (or are) connected to one or more storage media 606. The processor(s) 604 is (or are) also connected to a network interface 607 to allow the computer system 601A to communicate over a data network 609 with one or more additional computer systems and/or computing systems, such as 601B, 601C, and/or 601D (note that computer systems 601B, 601C and/or 601D may or may not share the same architecture as computer system 601A, and may be located in different physical locations, e.g., computer systems 601A and 601B may be located in a processing facility, while in communication with one or more computer systems such as 601C and/or 601D that are located in one or more data centers, and/or located in varying countries on different continents).

A processor can include a microprocessor, microcontroller, processor module or subsystem, programmable integrated circuit, programmable gate array, or another control or computing device.

The storage media 606 can be implemented as one or more computer-readable or machine-readable storage media. Note that while in the example embodiment of FIG. 6 storage media 606 is depicted as within computer system 601A, in some embodiments, storage media 606 may be distributed within and/or across multiple internal and/or external enclosures of computing system 601A and/or additional computing systems. Storage media 606 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLU-RAY®disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 600 contains one or more calibration module(s) 608. In the example of computing system 600, computer system 601A includes the calibration module 608. In some embodiments, a single calibration module may be used to perform at least some aspects of one or more embodiments of the methods. In other embodiments, a plurality of calibration modules may be used to perform at least some aspects of the methods.

It should be appreciated that computing system 600 is only one example of a computing system, and that computing system 600 may have more or fewer components than shown, may combine additional components not depicted in the example embodiment of FIG. 6, and/or computing system 600 may have a different configuration or arrangement of the components depicted in FIG. 6. The various components shown in FIG. 6 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

Geologic interpretations, models and/or other interpretation aids may be refined in an iterative fashion; this concept is applicable to embodiments of the present methods discussed herein. This can include use of feedback loops executed on an algorithmic basis, such as at a computing device (e.g., computing system 600, FIG. 6), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principals of the invention and its practical applications, to thereby enable others skilled in the art to best utilize the invention and various embodiments with various modifications as are suited to the particular use contemplated.

1-20. (canceled)

21. A method, comprising:
deploying a downhole tool in a wellbore, the downhole tool including a plurality of perforation charges disposed at respective predetermined locations in the wellbore;
signaling the plurality of perforation charges to detonate;
detecting a fluid flow rate at the respective predetermined locations using one or more sensors; and
determining respective extents of detonation associated with each perforation charge of the plurality of perforation charges based on the fluid flow rate at the respective predetermined locations.

22. The method of claim 21, wherein the one or more sensors comprise one or more intrinsic fiber optic sensors.

23. The method of claim 22, further comprising acquiring one or more measurements of a physical characteristic representative of the fluid flow rate using the one or more intrinsic fiber optic sensors.

24. The method of claim 23, wherein the physical characteristic comprises strain, vibration, temperature, or pressure, or a combination thereof.

25. The method of claim 22, wherein detecting the fluid flow rate at the respective predetermined locations comprises detecting respective fluid flow rates at the respective predetermined locations in the wellbore, and in a nearby wellbore, using the one or more intrinsic fiber optic sensors.

26. The method of claim 25, wherein determining the respective extents of detonations associated with each perforation charge of the plurality of perforation charges, comprises determining that one or more of the plurality of perforation charges did not detonate at the plurality of respective predetermined locations in the wellbore based on the respective fluid flow rates at the respective predetermined locations; and
wherein the method further comprises determining one or more actual locations that the one or more of the plurality of perforation charges detonated at based on one or more additional fluid flow rates at one or more additional locations.

27. The method of claim 26, further comprising calibrating a velocity model, or a tool-face orientation model, or both, based in part on the one or more actual locations where the perforation charges detonated.

28. The method of claim 25, further comprising deploying one or more additional perforation charges to respective locations that are different than the one or more actual locations.

29. The method of claim 28, further comprising signaling the one or more additional perforation charges to detonate at the respective locations.

30. The method of claim 21, further comprising deploying a cable into the wellbore, wherein the fluid flow rate at the respective predetermined locations is detected using one or more sensors of the cable.

31. The method of claim 30, wherein the cable is positioned in a tubular in the wellbore.

32. The method of claim 30, wherein the cable is positioned in an annulus between a tubular that extends in the wellbore and a wall of the wellbore.

33. The method of claim 21, further comprising deploying a cable into an adjacent wellbore, wherein the fluid flow rate at the predetermined locations is detected using one or more sensors of the cable.

34. The method of claim 33, wherein the cable is positioned in a tubular in the adjacent wellbore.

35. The method of claim 33, wherein the cable is positioned in an additional annulus between a tubular that extends in an adjacent wellbore and a wall of the adjacent wellbore

36. A system, comprising:
a downhole tool comprising a plurality of perforation charges, the downhole tool configured to be deployed in a wellbore, wherein the plurality of perforation charges are configured to be disposed at respective predetermined locations in the wellbore;
a cable configured to be deployed into the wellbore, wherein after the wellbore is perforated, the cable is configured to detect a fluid flow rate at the respective predetermined locations in the wellbore; and
a processor configured to determine respective extents of detonation associated with each perforation charge of the plurality of perforation charges based on the fluid flow rate at the respective predetermined locations.

37. The system of claim 33, wherein the cable comprises one or more intrinsic fiber optic sensors configured to acquire one or more measurements of a physical characteristic representative of the fluid flow rate.

38. The system of claim 33, wherein detecting the fluid flow rate at the respective predetermined locations comprises detecting respective fluid flow rates at the respective predetermined locations in the wellbore.

39. The system of claim 38, wherein the processor is configured to determine the respective extents of detonations associated with each perforation charge of the plurality of perforation charges by determining that one or more of the plurality of perforation charges did not detonate at the plurality of respective predetermined locations in the wellbore based on the respective fluid flow rates at the respective predetermined locations.

40. The system of claim 39, wherein the processor is further configured to determine one or more actual locations that the one or more of the plurality of perforation charges detonated at based on one or more additional fluid flow rates at one or more additional locations.
